(19) United States
(12) Patent Application Publication
(10) Pub. No.: US 2026/0225830 A1
(43) Pub. Date: Aug. 6, 2026

(54) SEPARATING DEVICE FOR SEPARATING STACKED SUBSTRATES

(71) Applicant: Phoenix Contact GmbH & Co. KG, Blomberg (DE)

(72) Inventors: Jürgen GRETSCHER, Dornhan (DE); Michael ESSLINGER, Rottweil (DE); Meinrad KEMPTER, Öhningen (DE)

(21) Appl. No.: 19/135,411

(22) PCT Filed: Nov. 17, 2023
(86) PCT No.: PCT/EP2023/082170

§ 371 Date: Jun. 4, 2025

(30) Foreign Application Priority Data
Dec. 7, 2022 (DE) 102022132555
Mar. 6, 2023 (BE) BE2023./5162
Mar. 6, 2023 (DE) 102023105409

(51) Int. Cl. B65G 49/06; B65G 59/06

(52) U.S. Cl. CPC B65G 49/068; B65G 59/066; B65G 2201/022

(57) ABSTRACT

A separating device for separating stacked substrates includes: a frame; a stack holder for receiving a stack of substrates; and a separating element mounted on the frame so as to be rotatable about an axis of rotation. The separating element is arranged such that the stack of substrates arranged in the stack holder are supportable thereon, and the separating element has a holder for engaging with one substrate of the stack of substrates and a sliding portion for sliding along a further substrate of the stack of substrates upon rotation of the at least one separating element about the axis of rotation.

### CROSS-REFERENCE TO PRIOR APPLICATIONS

This application is a U.S. National Phase application under 35 U.S.C. § 371 of International Application No. PCT/EP 2023/082170, filed on Nov. 17, 2023, and claims benefit to German Patent Application No. DE 10 2022 132 555.5, filed on Dec. 7, 2022;German Patent Application No. DE 10 2023 105 409.0, filed on Mar. 6, 2023; and Belgian Patent Application No. BE 2023/5162, filed on Mar. 6, 2023. The International Application was published in German on Jun. 13, 2024 as WO 2024/120797 A1 under PCT Article 21(2).

### FIELD

The invention relates to a separating device for separating stacked substrates, a printing system with such a separating device and a method for separating substrates.

### BACKGROUND

For example, substrates, in particular print media, to be printed one after the other by a printer are typically provided in stacks. To feed the print media to the printer, they are typically first separated from the stack. While this can usually be done easily with flexible print media such as paper pages, for example using rubberized rollers, a more complex mechanism is usually required when rigid print media are to be printed.

DE 20 2012 101 998 U1 describes a separating device which has an upper row of needles and a lower row of needles. If a print medium in the form of a rigid card is to be removed from a stack, the upper row of needles is disengaged from the stack by moving the upper row of needles laterally. Since the support is now missing, the cards in the stack fall down onto the bottom row of needles. The upper row of needles is then pushed forward again, with the card now lying between the upper row of needles and the lower row of needles. The next process step involves moving the lower row of needles laterally so that the bottom card of the stack falls onto a conveyor belt and can be transported away.

WO 2015/144392 A1 describes a solution with a plurality of slider elements and a chute for print media to be labeled in the form of identification label sets.

What the known devices have in common is that they are each based on a complex mechanism and are also limited in speed due to their design, because it is necessary to wait for the print media to fall between multiple forward and backward sliding movements. In addition, the known solutions are susceptible to tolerance-related variations in the dimensions of the print media.

### SUMMARY

In an embodiment, the present invention provides a separating device for separating stacked substrates, comprising: a frame; a stack holder for receiving a stack of substrates; and at least one separating element mounted on the frame so as to be rotatable about an axis of rotation. The at least one separating element is arranged such that the stack of substrates arranged in the stack holder are supportable thereon, and the at least one separating element has a holder configured to engage with one substrate of the stack of substrates and a sliding portion configured to slide along a further substrate of the stack of substrates upon rotation of the at least one separating element about the axis of rotation.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 is a schematic view of a printing system for printing on print media;

FIG. 2 is a view of a print medium in the form of a label mat with a plurality of break-out identification labels;

FIG. 3A to 3D are views of a separating device of the printing system according to FIG. 1 in different stages of conveying a print medium;

FIG. 4 is a view of the separating device according to FIG. 3A to 3D, showing a drive unit of the separating device;

FIG. 5 is a view of a passage of the separating device according to FIG. 3A to 3D; and

FIGS. 6A and 6B are views of the separating device of the printing system according to FIG. 1 in different stages of conveying different print media.

### DETAILED DESCRIPTION

In an embodiment, the present invention improves the separation of substrates.

Accordingly, a separating device for separating stacked substrates, in particular print media, comprises a frame and a stack holder for receiving a stack of substrates, in particular print media. The separating device further comprises at least one separating element which is mounted on the frame so as to be rotatable about an axis of rotation, which element is arranged such that a stack of substrates, in particular print media, arranged in the stack holder can be supported thereon, and which has (at least) one holder for engagement with one of the substrates, in particular print media, and a sliding portion, which sliding portion is designed to slide along another of the substrates, in particular print media, when the at least one separating element rotates about the axis of rotation.

This is based on the idea of realizing separation by means of a rotatable separating element instead of multiple levels of sliders, which element simultaneously pulls a substrate, in particular a print medium, from the stack and supports the remaining stack, in particular the stack above it. No change in the direction of movement is necessary here. This makes the mechanism particularly simple and at the same time robust and therefore reliable. Furthermore, there is no need to wait until one or more substrates, in particular print media, fall down due to the effect of gravity alone; rather, the removal of a substrate, in particular print medium, to be separated from the stack can be done actively. This can also significantly reduce the likelihood of jamming. The substrates, in particular print media, can be rigid objects which, unlike, e.g., paper, do not deform or deform only slightly due to their own weight. Another advantage is that the separating device can optionally also be used as a stacking device for stacking individual substrates when the direction of rotation is reversed. This results in a large number of identical parts and simple production.

Optionally, the sliding portion of the at least one separating element is made in the shape of a circular arc. A substrate arranged in the stack holder (and a stack of substrates arranged therein) can be supported on the circular-arc-shaped sliding portion. This allows the separating element to be repositioned after separating a first substrate in order to separate a second substrate without displacing the remaining stack. The separating element therefore has a dual function.

The holder of the at least one separating element optionally has a C-shaped contour or a plurality of C-shaped contours. This allows each substrate to be removed from the rest of the stack with particular precision using the rotating movement.

The holder of the at least one separating element defines, for example, an interior space and an opening. It can be provided that the opening is narrower than the interior space. For example, a clear width of the opening is smaller than (e.g., parallel to) a clear width of the interior. This allows precise separation and, at the same time, jam-free movement because the substrate can be moved in the rotating interior.

The at least one separating element is designed in particular to lower the substrates individually vertically into an output region. For example, the individual substrates can be placed as print media e.g., on a transport device and transported to a printing region or to a printer.

The separating device can comprise a drive unit arranged laterally offset relative to the stack holder. This enables a particularly compact design that can also be easily implemented in a modular manner.

The at least one separating element can be capable of being rotated unidirectionally multiple times about the axis of rotation, e.g., in order to separate a plurality of substrates one after the other. For example, one substrate is carried along with each complete rotation. This enables continuous and consistent transport.

The at least one separating element can be disk-shaped. This allows for a narrow design and at the same time a simple construction,

The separating device can have two separating elements that can be rotated in opposite directions. The holders of the two separating elements can be brought into engagement with opposite sides, in particular end faces, of a substrate. This allows a particularly precise and smooth-running construction to be achieved.

Furthermore, the separating device can comprise a first pair of separating elements that can be rotated opposite to a second pair of separating elements. For example, each substrate can be removed from the stack at four corners at the same time, with the stack above it also being supported at four corners, which allows for particularly orderly separation without jamming.

According to one aspect, a separating device for separating stacked substrates, in particular print media, is provided. The separating device can be designed as described above. The separating device comprises a frame and a stack holder with two guides, between which a stack of rigid substrates, in particular print media, can be accommodated, wherein the guides are arranged at a first distance from one another. The separating device further comprises at least two separating elements mounted on the frame so as to be rotatable about an axis of rotation in opposite directions to one another, which elements have, in at least one rotational position, a second distance from one another which is smaller than the first distance. Furthermore, the separating elements have holders which can be aligned with one another by rotating the separating elements, so that a third distance between bottoms of the holders is greater than the second distance. As regards the advantages, reference is made to the above statements. Optionally, the stack holder is designed as part of the frame. For example, the frame and the stack holder are formed as a single piece.

The third distance can be equal to or greater than the first distance. This ensures particularly smooth-running separation.

Optionally, the separating device is designed to separate flat and rigid substrates, in particular print media. In particular, it can be provided that the separating device is designed to separate substrates in the form of label mats, each with a plurality of break-out identification labels. Such label mats are also called marking element mats.

At least one rigid substrate, in particular a print medium, in particular in the form of a label mat with a plurality of break-out identification labels, can be arranged in the stack holder.

The separating device makes it possible for a plurality of (particularly rigid) substrates with different dimensions, in particular with different heights, to be arranged in the stack holder and to be separated with the separating device. For example, a first substrate with a first height and a second substrate with a second height are arranged in the stack holder and can be separated with the separating device, wherein the second height is, for example, greater than the first height, for example at least twice as large. This means that a wide variety of substrates can be separated using the same separation device. It can be provided that the substrates have different heights or, for example, only individual or all of the identification labels thereof, if the substrates are designed in the form of label mats.

The substrate can rest on each of the at least two separating elements before separation. It should be noted that the stack holder can also be filled with one or more additional substrates during a separation. This allows for uninterrupted processing.

According to one aspect, a printing system is provided. The printing system comprises the separating device according to any of the embodiments described herein. Furthermore, the printing system comprises a printer and a transport device for transporting the print media from the separating device to the printer. As regards the advantages, reference is made to the above statements relating to the separating device.

The transport device of the printing system includes, for example, one or more rails for guiding the print media. The separating device can be arranged so that individual print media can be placed one after the other on the rail(s). This results in a particularly compact design. Alternatively or additionally, a movable transport shuttle can be provided on which the individual print media can be placed.

According to one aspect, a method for separating substrates, in particular print media, is specified, in particular using the separating device according to any embodiment described herein. The separating device comprises a frame, a stack holder for accommodating a stack of rigid substrates, in particular print media, and at least one separating element mounted on the frame so as to be rotatable about an axis of rotation. The method comprises the following steps: arranging a rigid substrate, in particular a print medium (in particular a stack of such print media), in the stack holder; and conveying the (in particular the lowermost) substrate, in particular a print medium, arranged in the stack holder to an output region by rotating the at least one separating element about the axis of rotation, wherein the substrate, in particular print medium, is brought into engagement with a holder of the at least one separating element. With regard to the advantages, reference is again made to the above statements on the separating device described above.

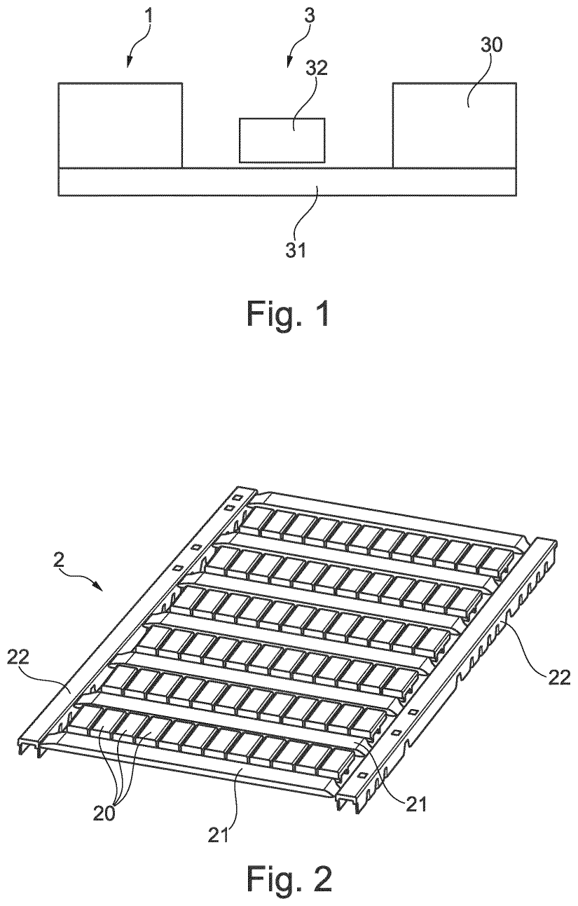

FIG. 1 shows a printing system 3 for printing on a plurality of individually printable substrates in the form of print media. For this purpose, the printing system 3 comprises a separating device 1 into which a stack of print media can be fed automatically or manually. A transport device 31 transports individual print media output by the separating device 1 to a printer 32 of the printing system 3.

The printer 32 prints the individual print media one after the other. From the printer 32, the print media are transported to a stacking device 30 by means of the transport device 31 in the example shown. The stacking device 30 stacks the individual printed print media to form a stack, which can then be removed manually or automatically from the stacking device 30. Instead of the stacking device 30, it could also be provided that the printed print media are simply ejected, for example.

FIG. 2 shows an example of such a substrate in the form of a print medium 2. The print medium 2 comprises a plurality of identification labels 20. The identification labels 20 are each formed on (at least) one of a plurality of webs 21. The webs 21 are arranged parallel to one another and with the identification labels 20 between two guides 22. The webs 21 are each fixed to both guides 22. The print medium 2 is formed in one piece. For example, it is an injection-molded part. In particular, the print medium 2 can consist of a plastics material or comprise a plastics material. The individual identification labels 20 can be broken off from the webs 21. For example, an identification label 20 printed with the printer 32 can be attached to an electrical or electronic component in order to identify it. For this purpose, the identification labels 20 each have locking elements for locking with a corresponding component.

The print medium 2 can also be called a mat or card. It is disk-shaped and rigid. Due to the weight of the print medium 2, the print medium 2 does not bend or only bends slightly, for example when it is held only on one side or corner.

The print medium 2 has a length, a width and a height. The height is smaller than the length and width. The width is smaller than the length. The guides 22 extend along the length. The end faces of the print medium 2 extend across its width.

Depending on the required shape and size of the identification labels 20, the print medium 2 can have a larger or smaller number of identification labels 20 and webs 21 for holding the identification labels 20.

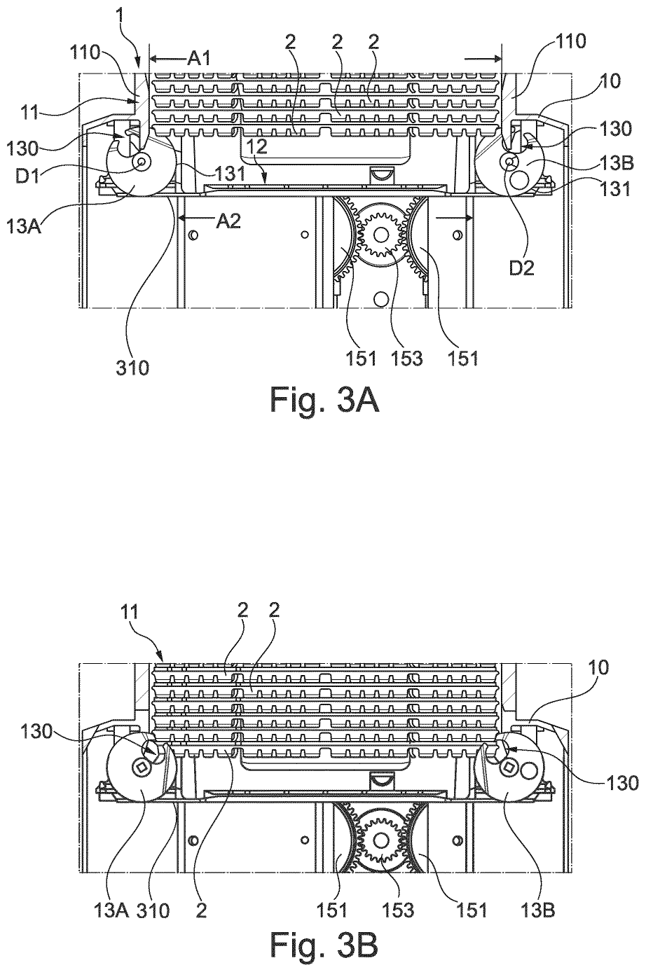

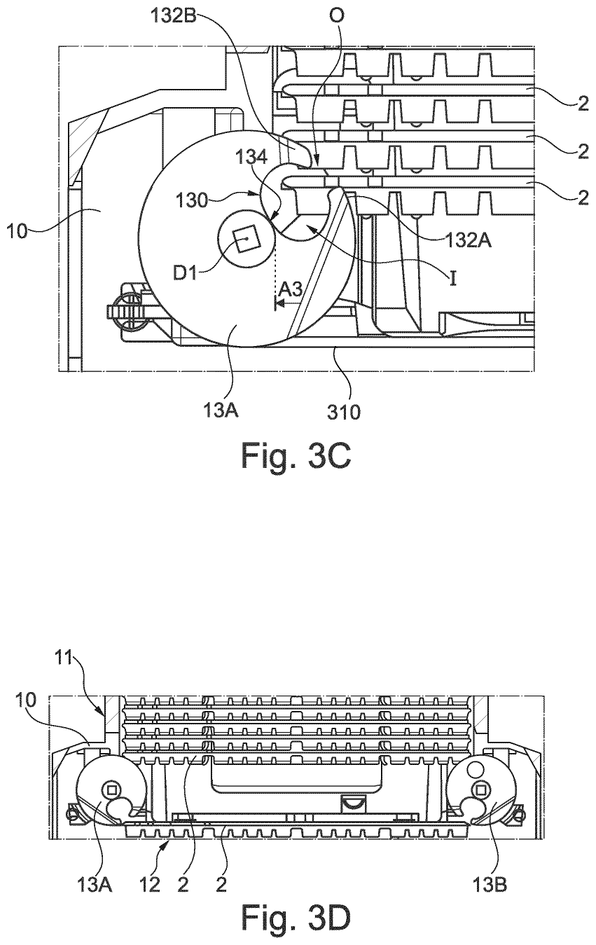

FIG. 3A to 3D show the separating device 1 and its mode of operation.

The separating device 1 comprises a frame 10, a stack holder 11 and an output region 12. When the separating device 1 is used as intended, the output region 12 is arranged vertically below the stack holder 11. By means of the transport device 31, a print medium 2 can be moved, in this case slid, from the output region 12 to the printer 32. For this purpose, the transport device 31 has a pair of rails 310, wherein each of the guides 22 of the print medium 2 sits on one of the rails 310 and is thereby guided in a longitudinally displaceable manner. The rails 310 of the transport device 31 are spaced apart from one another. The rails 310 of the transport device 31 run parallel to one another. During the use as intended of the separating device 1 (and the printing system 3), the rails 310 extend horizontally.

The stack holder 11 comprises two guides 110, between which a stack of rigid print media 2 can be accommodated, e.g., automatically or manually inserted. The guides 110 are arranged at a first distance Al from one another. The first distance Al corresponds approximately to the length of the print media 2, which are guided vertically between the guides 110.

Furthermore, the separating device 1 generally comprises at least one separating element 13A, 13B; in the example shown, there are exactly four separating elements 13A, 13B. In the example shown, each of the separating elements 13A, 13B is mounted on the frame 10 so that it can rotate completely, i.e., by 360 degrees, about an associated axis of rotation D1, D2.

However, this is not mandatory, and alternatively or additionally it can be provided, for example, that the separating elements 13A, 13B can be rotated forwards and back again for each separating process. The separating device 1 comprises a first pair of separating elements 13A, which is rotatable in a first direction (clockwise in the view according to FIG. 3A), and a second pair of separating elements 13B, which is rotatable in a second direction opposite to the first direction (counterclockwise in the view according to FIG. 3A). The two pairs are arranged on opposite sides of the stack holder 11. Alternatively, however, it would also be conceivable, for example, for the separating device to have exactly two separating elements, which are arranged, for example, on opposite sides of the stack holder 11.

Of the four separating elements 13A, 13B in the present case, two (namely the first pair) are arranged on one side of the stack holder 11, and two further ones (namely the second pair) are arranged on an opposite side of the stack holder 11, and thus also correspondingly on opposite sides of a print medium 2 positioned in the stack holder 11. In the example shown, the separating elements 13A, 13B engage the end faces of the print medium 2. Specifically, in the example shown the separating elements 13A, 13B are arranged such that they are located at four corners of a rectangular print medium 2 positioned in the stack holder 11.

In the present case, the separating elements 13A, 13B are of identical design. The first pair is oriented in the opposite direction to the second pair.

The separating elements are each arranged in such a way that a stack of print media 2 arranged in the stack holder 11 can be supported thereon. Furthermore, the separating elements each have a holder 130 for engagement with one (the lowermost) of the print media 2 and a sliding portion 131. The sliding portion 131 is configured to slide along another of the print media 2 (the second from the bottom) when the at least one separating element 13A, 13B is rotated about the axis of rotation D1, D2.

The sliding portion 131 of the separating element 13A, 13B in each case is circularly arc-shaped and in this case arranged concentrically to the corresponding axis of rotation D1, D2. The holders 130 of the separating elements 13A, 13B are each formed on one side of the corresponding axis of rotation D1, D2. It should be noted at this point that the separating elements 13A, 13B shown each have exactly one holder 130, but that each of the separating elements 13A, 13B could alternatively have more than one holder 130, e.g., two or three holders 130. In general, each separating element 13A, 13B has for example at least one holder 130.

The separating elements 13A, 13B are flat (along the axis of rotation D1, D2). The separating elements 13A, 13B are disk-shaped in the present case. The separating elements 13A, 13B can also be referred to as profiled disks. The separation is therefore carried out using profiled disks.

For example, from FIG. 3C it can be seen that the holders 130 of the separating elements 13A, 13B each have a C-shaped contour. The holders 130 are each bordered by two projections 132A, 132B facing one another. Between the projections 132A, 132B, an opening O to an interior space I of the holder 130 is formed. The opening O is narrower than the interior space I. Starting from the opening O, the interior space I thus widens. Parallel to the width of the opening O, the interior space I has a greater width. Thus, the end of the print medium 2 arranged in the holder 130 can pivot in the holder 130.

One of the projections 132A, 132B, namely the projection 132A on which a print medium 2 to be separated rests when it projects into the holder 130, has a rounded end. As a result, this projection 132A slides along the underside of the print medium 2 without jamming when the separating element 13A rotates. The other projection 132B is inserted between the lowermost two print media 2 when the separating element 13A rotates, and thus reliably separates them. In the example shown, this projection 132B has a molded end so that it can be securely inserted between the two lowermost print media 2 of the stack, even in the case of larger manufacturing tolerances of the print media 2. The projections 132A, 132B serve as runners.

The separating device 1 is placed on the transport device 31. The separating elements 13A, 13B are each arranged next to one of the rails 310 or aligned with one of the rails 310 of the transport device 31, wherein for example a recess is then formed in each of the two rails 310 for, in each case, two of the separating elements 13A, 13B.

Referring to FIG. 3A to 3D, a method for separating print media 2 with the separating device 1 is now explained.

In a first step, at least one print medium 2, in particular a stack of print media 2, for example in the form of the print medium 2 shown in FIG. 2, is inserted into the stack holder 11 (see e.g., FIG. 3A). The (lowest) print medium 2 then rests on each of the four separating elements 13A, 13B, namely on the sliding surface 131. A second distance A2 is formed between the opposite (counter-rotatable) separating elements 13A, 13B. Specifically, the second distance A2 is the shortest distance between the aligned sliding surfaces 131. This second distance A2 is smaller than the first distance A1. The separating elements 13A, 13B thus protrude into a shaft defined by the guides 110. The print media 2, which have a length which is (slightly) smaller than the first distance (or is equal to it), but larger than the second distance A2, rest on the separating elements 13A, 13B.

Next, the print medium 2 arranged at the bottom in the stack holder 11 is conveyed to the output region 12 by rotating the separating elements 13A, 13B about the axis of rotation D1, D2, wherein the print medium 2 is brought into engagement with a holder 130 of each of the separating elements 13A, 13B. The separating elements 13A, 13B grip the print medium 2 (lowermost in the stack) and separate it from the print media 2 above it in the stack.

In the present case, the separating elements 13A, 13B are rotated completely once about the corresponding axis of rotation D1, D2, i.e., by 360 degrees, for each print medium 2 to be separated. Alternatively, it would also be conceivable for the separating elements 13A, 13B to each have two (or more) holders 130, so that two (or more) print media 2 can be separated per complete rotation. Because the separating elements 13A, 13B are completely rotatable about the axes of rotation D1, D2, the separation of a plurality of print media 2 can be carried out by a unidirectional rotational movement, i.e., without switching the direction of rotation. This allows for a particularly simple drive mechanism, which is described in more detail below, and which also does not tend to jam, due to the lack of a switching of the direction of rotation. The rotational movement can be stopped between the transport of two print media 2, or alternatively can continue to run continuously. All separating elements 13A, 13B move synchronously. The movements of the separating elements 13A, 13B are coupled to one another.

FIG. 3B shows a moment in which the holders 130 engage around the end faces of the print medium 2, shortly before the separating elements 13A, 13B separate the lowermost print medium 2 from the print medium 2 above it, by means of the upper projection 132B, through further rotation about the axes of rotation D1, D2. The lowest print medium 2 is then moved vertically downwards.

FIG. 3C shows an enlarged view of a detail from FIG. 3B. It is also illustrated therein that, as soon as the holders 130 of the opposing separating elements 13A, 13B are aligned with one another, a third distance A3 is formed between bottoms 134 of the holders 130. In the example shown, the third distance A3 is approximately the same as (alternatively, is, e.g., larger than) the second distance A2. The bottoms 134 of the holders 130 represent the part of the edge of the holder 130 facing the corresponding axis of rotation D1, D2 (e.g., the half of the edge facing the corresponding axis of rotation D1, D2).

FIG. 3D shows a moment in which the separating elements 13A, 13B have continued to rotate and the separated print medium 2 has already been deposited on the rails 310 in the output region 12. Depending on the rotation speed, this can occur passively due to gravity once the openings O are rotated downwards far enough, or actively by means of the upper projections 132B.

The print medium 2 is thus separated and can be transported to the printer 32 by the transport device 31.

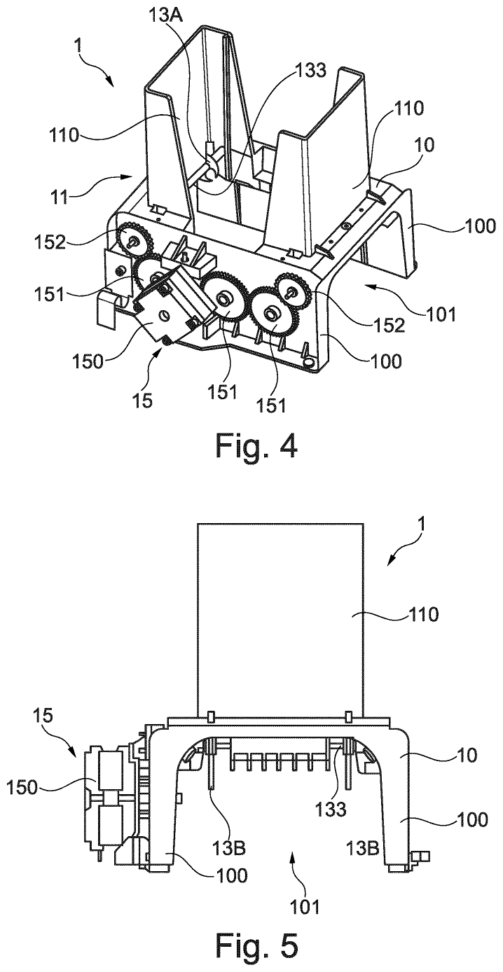

FIGS. 4 and 5 show a drive unit 15 of the separating device 1. The drive unit 15 comprises a motor 150 and, in the example shown, a plurality of gears 151, 152 (although, of course, other counter-rotating drive types are also conceivable). Furthermore, it can be seen that each pair of separating elements 13A, 13B is fixed in a rotationally fixed manner to a shaft 133. Furthermore, one of the gears 152 is fixed in a rotationally fixed manner to each of the two shafts 133. In order to effect the opposite directions of rotation of the pairs of separating elements 13A, 13B (and the two shafts 133), the drive unit 15 has a number of gears 151, 152 connected in series that differs by one for the first pair and the second pair.

Thus, a drive pinion 153 of the motor 150 (see for example FIGS. 3A and 3B) drives the shaft 133 shown on the left in FIG. 4 via a total of two gears 151, 152, while the drive pinion 153 drives the shaft 133 arranged on the right in the view of FIG. 4 via a total of three gears 151, 152.

A sensor (e.g., in the motor 15) detects the position of the separating elements 13A, 13B, i.e., in particular a current angle of rotation (e.g., relative to the frame 10). In this way the motor 15 can adjust the separation to the conveying by the transport device 31.

As can be seen in particular from FIGS. 4 and 5, the frame 10 has two arms 100. While the guides 110 of the stack holder 11 extend vertically upwards, the arms 100 extend vertically downwards. There is a passage 101 between the arms 100. The passage 101 is designed to receive a portion of the transport device 31 of the printing system 3. In the assembled state, the transport device 31 of the printing system 3 extends in the passage 101.

The drive device 15 is arranged laterally offset from the stack holder 11. This frees up the installation space under the stack holder 11. This allows a particularly compact and also modular design. In addition, the installation space in front of and behind the end faces of the print media 2 is not blocked by the drive.

When rotated in the opposite direction, the separating device can also be used as a stacking device for stacking individual print media 2. This results in a large number of identical parts. For example, the stacking device 30 is constructed in the same way as the separating device 1.

Specifically, the drive device 15 is mounted on one of the arms 100. The drive device 15 is arranged below the stack holder 11.

The active separation of the print media 2 enables reliable separation at high speed. The separation at the end face enables a particularly simple construction. This makes the separation device particularly robust against length tolerances of the print media 2. For example, it is not necessary to precisely meet a lateral recess.

Since the separation, lowering and retention of the print media 2 is realized by a rotational movement (per separating element 13A, 13B) in only one direction of rotation, an empty stroke can be avoided. Furthermore, alternating loading and the corresponding wear are eliminated. In addition, very few components are required, thus achieving low complexity, susceptibility to failure, and noise levels.

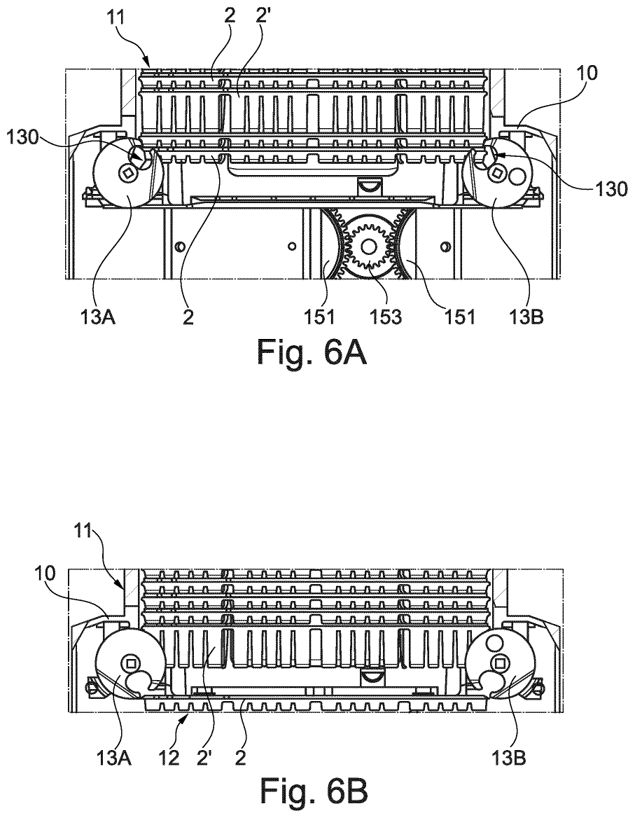

FIGS. 6A and 6B illustrate that with the described separating device 1 it is possible to separate differently shaped print media 2, 2′, and in particular to stack them simultaneously in the stack holder 11.

In the present case, for example, a plurality of comparatively thin print media 2 are arranged in the stack, as well as a print medium 2′ that is thicker in comparison (in the direction in which the print media 2, 2′ are stacked on top of one another). The separating device 1 can process such mixed, i.e., non-uniform, stacks, in this case without changing any settings.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Separating device
10 frame
100 Arm
101 Passage
11 Stack holder
110 Guide
12 Output region
13A, 13B Separating element
130 Absorption
131 Sliding segment
132A, 132B Projection
133 Shaft
134 Bottom
15 Drive unit
150 Motor
151 Gear
152 Gear
153 Drive pinion
2; 2′ Printing medium (substrate)
20 Identification tag
21 Ridge
22 Guide
3 Printing system
30 Stacking device
31 Transport device
310 Rail
32 Printer
A1-A3 Distance
D1, D2 Axis of rotation
I Interior
O Opening

1. A separating device for separating stacked substrates,

24. comprising:
a frame;
a stack holder for receiving a stack of substrates; and
at least one separating element mounted on the frame so as to be rotatable about an axis of rotation the at least one separating element is being arranged such that the stack of substrates arranged in the stack holder can are supportable thereon, and the at least one separating element having a configured to engage with one substrate of the stack of substrates and a sliding portion configured to slide along a further substrate of the stack of substrates upon rotation of the at least one separating element about the axis of rotation.

2. The separating device of claim 1, wherein the sliding portion of the at least one separating element comprises a circular arc.

3. The separating device of claim 1, wherein the holder of the at least one separating element has at least one C-shaped contour.

4. The separating device of claim 1, wherein the holder of the at least one separating element defines an interior space and an opening, and
wherein the opening is narrower than the interior space.

5. The separating device of claim 1, wherein the at least one separating element is configured to lower substrates of the stack of substrates individually vertically into an output region.

6. The separating device of claim 1, further comprising:
a drive unit arranged laterally offset from the stack holder.

7. The separating device of claim 1, wherein the at least one separating element is rotatable unidirectionally multiple times about the axis of rotation so as to convey, one after the other, a plurality of substrates of the stack of substrates.

8. The separating device of claim 1, wherein the at least one separating element comprises a disk.

9. The separating device of claim 1, wherein the at least one separating element comprises two oppositely rotatable separating elements, and
wherein the holders of the two oppositely rotatable separating elements are configured to be brought into engagement with opposite sides of a substrate of the stack of substrates.

10. The separating device of claim 9, wherein the two oppositely rotatable separating elements comprise a first pair of separating elements that are rotatable opposite to a second pair of separating elements.

11. The separating device of claim 1, further comprising:
a stack holder with two guides between which a stack of rigid substrates are receivable, the two guides being arranged at a first distance from one another; and
at least two separating elements mounted on the frame so as to be rotatable in opposite directions, each about a corresponding axis of rotation, which in at least one rotational position have a second distance from one another which is smaller than the first distance, and which have holders that are alignable with one another so that a third distance between bottoms of the holders is greater than the second distance.

12. The separating device of claim 11, wherein the third distance is equal to or greater than the first distance.

13. The separating device of claim 11, wherein at least one rigid substrate is arranged in the stack holder, the at least one rigid substrate comprising a label mat with a plurality of break-out identification labels.

14. The separating device of claim 13, wherein the at least one rigid substrate rests on each separating element of the at least two separating elements.

15. The separating device of claim 1, wherein substrates with different dimensions are arrangeable in the stack holder and separable with the separating device, and
wherein the dimensions comprise heights.

16. A printing system, comprising:
the separating device claim 1;
a printer; and
transport device configured to transport the substrates as print media from the separating device to the printer.

17. The printing system of claim 16, wherein the transport device comprises one or more rails configured to guide the substrates, and
wherein the separating device is arranged such that individual substrates are placeable on the one or more rails.

18. A method for separating substrates with the separating device of claim 1, the method comprising:
arranging a rigid substrate in the stack holder; and
conveying the rigid substrate arranged in the stack holder to an output region by rotating the at least one separating element about the axis of rotation; and
bringing the substrate into engagement with a holder of the at least one separating element.
